(19) United States
(12) Patent Application Publication
(10) Pub. No.: US 2012/0106711 A1
(43) Pub. Date: May 3, 2012

(54) X-RAY TUBE WITH BONDED TARGET AND BEARING SLEEVE

(75) Inventors: Donald Robert Allen, Waukesha, WI (US); Michael Hebert, Milwaukee, WI (US); Kenwood Dayton, Milwaukee, WI (US)

(73) Assignee: GENERAL ELECTRIC COMPANY, Schenectady, NY (US)

(21) Appl. No.: 12/915,784

(22) Filed: Oct. 29, 2010

(51) Int. Cl. H01J 35/10; B23P 11/00

(52) U.S. Cl. 378/132; 29/428

(57) ABSTRACT

The embodiments disclosed herein relate to the thermal regulation of components within an X-ray tube by transferring heat between the anode and the rotary mechanism to which the anode is attached. For example, in one embodiment, an X-ray tube is provided. The X-ray tube generally includes a fixed shaft, a rotating bearing sleeve disposed about the fixed shaft and configured to rotate with respect to the fixed shaft via a rotary bearing, and an electron beam target disposed about the bearing sleeve and configured to rotate with the bearing sleeve. The electron beam target is permanently bonded to the bearing sleeve.

### BACKGROUND OF THE INVENTION

The subject matter disclosed herein relates to the thermal regulation of components within an X-ray tube, and more specifically to heat transfer between the anode and the rotary mechanism to which the anode is attached.

A variety of diagnostic and other systems may utilize X-ray tubes as a source of radiation. In medical imaging systems, for example, X-ray tubes are used in projection X-ray systems, fluoroscopy systems, tomosynthesis systems, and computer tomography (CT) systems as a source of X-ray radiation. The radiation is emitted in response to control signals during examination or imaging sequences. The radiation traverses a subject of interest, such as a human patient, and a portion of the radiation impacts a detector or a photographic plate where the image data is collected. In conventional projection X-ray systems the photographic plate is then developed to produce an image which may be used by a radiologist or attending physician for diagnostic purposes. In digital X-ray systems a digital detector produces signals representative of the amount or intensity of radiation impacting discrete pixel regions of a detector surface. In CT systems a detector array, including a series of detector elements, produces similar signals through various positions as a gantry is displaced around a patient.

The X-ray tube is typically operated in cycles including periods in which X-rays are generated, interleaved with periods in which the X-ray source is allowed to cool. In X-ray tubes having rotating anodes, the large amount of heat that is generated at the anode during electron bombardment can limit the amount of electron beam flux suitable for use. Such limitations may lower the overall flux of X-rays that are generated by the X-ray tube. The generated heat may be removed from the anode through various features, such as coolant and other X-ray tube components. One example is the transfer of heat through the shaft. Unfortunately, inefficient heat transfer to the shaft may not allow continuous operation of the X-ray tube, and may also result in unsuitable X-ray tube temperatures, which can reduce the expected useful life of the tube. There is a need, therefore, for an approach for limiting overheating of X-ray tubes. Specifically, it is now recognized that there is a need for improved heat transfer between components of an X-ray tube.

### BRIEF DESCRIPTION OF THE INVENTION

In one embodiment, an X-ray tube is provided. The X-ray tube generally includes a fixed shaft, a rotating bearing sleeve disposed about the fixed shaft and configured to rotate with respect to the fixed shaft via a rotary bearing, and an electron beam target disposed about the bearing sleeve and configured to rotate with the bearing sleeve, the electron beam target being permanently bonded to the bearing sleeve.

In another embodiment, an X-ray tube is provided. The X-ray tube generally includes a fixed shaft, a rotating bearing sleeve disposed about the fixed shaft and configured to rotate with respect to the fixed shaft via a rotary bearing, the bearing sleeve comprises a shoulder having an axial face, an electron beam target disposed about the bearing sleeve and configured to rotate with the bearing sleeve, and a bonding layer disposed between the axial face of the shoulder and the electron beam target for securing the target to the bearing sleeve.

In a further embodiment, a method for making an X-ray tube is provided. The method generally includes disposing a rotating bearing sleeve about a fixed shaft, the bearing sleeve comprising a shoulder having an axial face, disposing an electron beam target about the bearing sleeve, the electron beam target being rotatable with the bearing sleeve during operation, and bonding the target and the axial face of the bearing sleeve shoulder.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of an embodiment of an X-ray tube having features configured to facilitate the transfer of heat between a portion of a rotating anode and a portion of a bearing sleeve to which the anode is attached, in accordance with an aspect of the present disclosure;

FIG. 2 is an illustration of an embodiment of a portion of the anode assembly of FIG. 1 having a metallic bonding layer disposed between a portion of the anode and the bearing sleeve, in accordance with an aspect of the present disclosure;

FIG. 3 is an illustration of an embodiment of a portion of the anode assembly of FIG. 1 having a metallic braze disposed between a portion of the anode and the bearing sleeve, and a pair of electrodes configured to melt the metallic braze, in accordance with an aspect of the present disclosure;

FIG. 4 is an illustration of an embodiment of a portion of the anode assembly of FIG. 1 having a metallic gasket and a pair of solder layers disposed between a portion of the anode and the bearing sleeve being, the gasket and pair of solder layers being configured to melt upon application of heat from a heat source to form an alloy in accordance with an aspect of the present disclosure;

FIG. 5 is an illustration of an embodiment of a portion of the anode assembly of FIG. 1 having a brazed metallic layer disposed on a portion of the anode and the bearing sleeve being, and a solder disposed between the brazed metallic layers, the solder and brazed metallic layers being configured to melt upon application of heat from a heat source to form an alloy in accordance with an aspect of the present disclosure;

FIG. 6 is a process flow diagram illustrating an embodiment of a method for manufacturing and using the X-ray tube having heat transfer features in accordance with the present disclosure.

### DETAILED DESCRIPTION OF THE INVENTION

As noted above, thermal conduction between various components of an X-ray tube may be important for allowing continued use of the X-ray tube, as well as utilization for high power (i.e., high X-ray flux) imaging sequences. One example of an imaging sequence that may benefit from high X-ray flux is a computed tomography (CT) imaging sequence, where the source of X-ray radiation (i.e., a source including the X-ray tube) is displaced about a patient or subject of interest on a gantry. Due to the motion of the X-ray tube about the patient, it is desirable that a flux of X-rays be provided that is sufficient to traverse the subject of interest and produce an image with low levels of noise. Accordingly, there is a continued need for improved heat conduction away from the X-ray target within the X-ray tube.

For some X-ray targets, there may be a number of design considerations, including heat conduction, retention of the target to limit target movement, and maintenance of the bearing tolerance. Generally, only two of these three considerations may be addressed in a given implementation. That is, the movement of the target or the movement of the bearing may be controlled. The present embodiments are directed towards a rigid attachment between the X-ray target and a spiral groove bearing, which limits undesirable non-rotational movement of the target while maintaining heat conduction between the target and the bearing. Such a rigid attachment leverages a reduction in the relative motion of the target, which eliminates the risk of particles and unbalance, with variable bearing tolerance, which may reduce the load that the bearing is able to support. In addition to reducing the risk of X-ray target rupture due to excessive heating, the present target attachment methods may keep the bearing at relatively low temperatures (<400° C.). Such low bearing temperatures may mitigate the risk of excessive intermetallic formation due to reaction of liquid metal materials inside the spiral groove bearing.

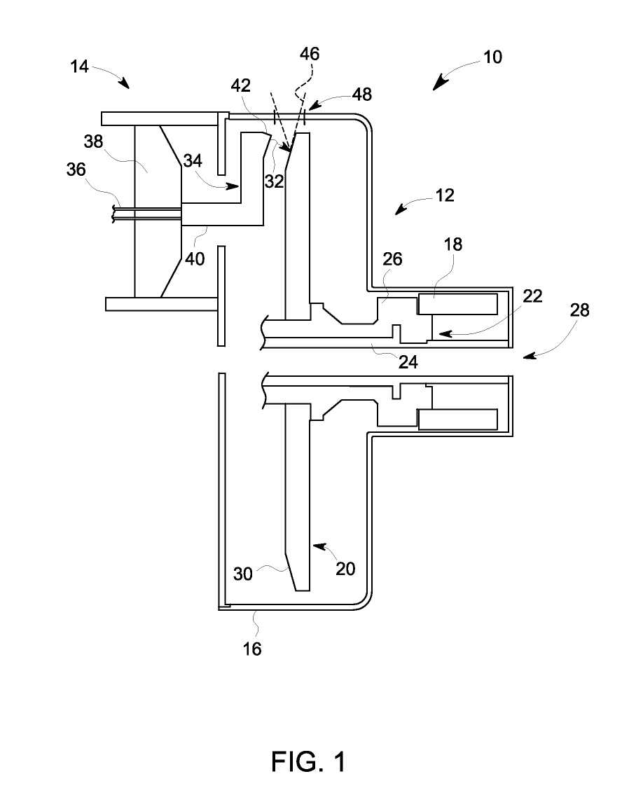

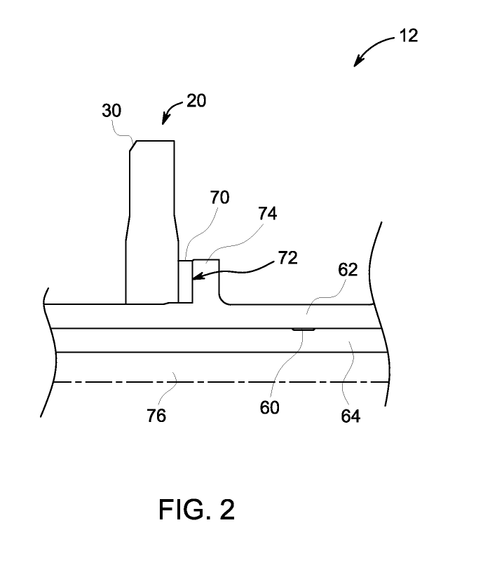

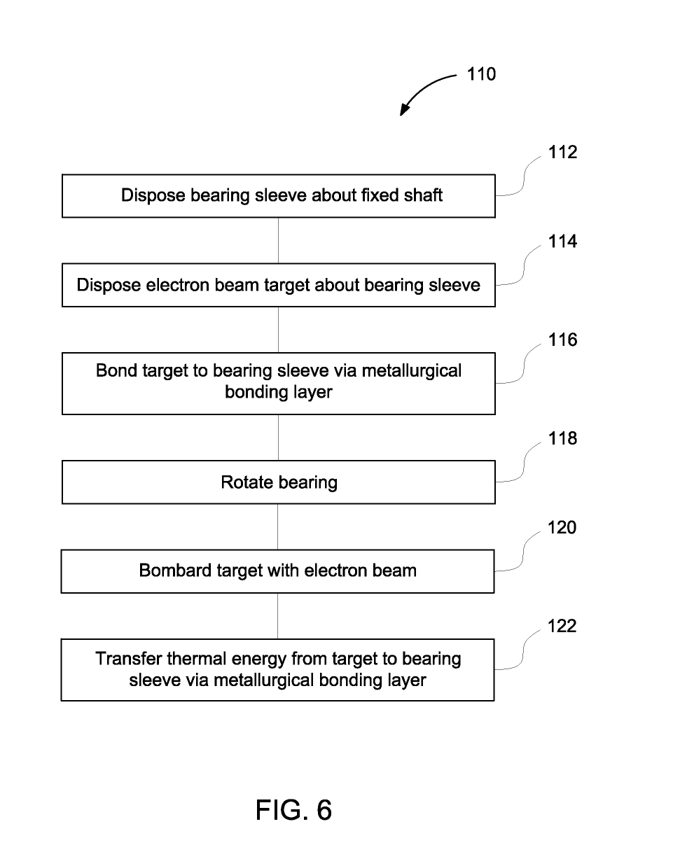

Specifically, the present embodiments provide a metallic bonding layer between a portion of the X-ray target and a portion of a component of the spiral groove bearing, which is described with reference to FIGS. 1 and 2. The metallic bonding layer may be formed by a variety of methods, including via a resistance braze, via a transient liquid phase bond with a metallic gasket, and/or via a transient liquid phase bond with a brazed metallic layer, embodiments of which are described with reference to FIGS. 2-5. A method of making and using an X-ray tube having a metallic bonding layer is described with reference to FIG. 6.

With the foregoing in mind, FIG. 1 illustrates an embodiment of an X-ray tube 10 that may include features configured to provide enhanced heat conduction in accordance with the present approaches. In the illustrated embodiment, the X-ray tube 10 includes an anode assembly 12 and a cathode assembly 14. The X-ray tube 10 is supported by the anode and cathode assemblies within an envelope 16 defining an area of relatively low pressure (e.g., a vacuum) compared to ambient. The envelope 16 may be within a casing (not shown) that is filled with a cooling medium, such as oil, that surrounds the envelope 16. The cooling medium may also provide high voltage insulation.

The anode assembly 12 generally includes a rotor 18 and a stator outside of the X-ray tube 10 (not shown) at least partially surrounding the rotor 18 for causing rotation of an anode 20 during operation. The anode 20 is supported in rotation by a bearing 22, which may be a ball bearing, spiral groove bearing, or similar bearing. In general, the bearing 22 includes a stationary portion 24 and a rotary portion 26 to which the anode 20 is attached. Additionally, as illustrated, the X-ray tube 10 includes a hollow portion 28 through which a coolant, such as oil, may flow. The bearing 22 and its connection to the anode 20 are described in further detail below with respect to FIGS. 2-5. In the illustrated embodiment, the hollow portion 28 extends through the length of the X-ray tube 10, which is depicted as a straddle configuration. However, it should be noted that in other embodiments, the hollow portion 28 may extend through only a portion of the X-ray tube 10, such as in configurations where the X-ray tube 10 is cantilevered when placed in an imaging system.

The front portion of the anode 20 is formed as a target disc having a target or focal surface 30 is formed thereon. During operation, as the anode 20 rotates, the focal surface 30 is struck by an electron beam 32. The anode 20 may be manufactured of any metal or composite, such as tungsten, molybdenum, copper, or any material that contributes to Bremsstrahlung (i.e., deceleration radiation) when bombarded with electrons. The anode's surface material is typically selected to have a relatively high refractory value so as to withstand the heat generated by electrons impacting the anode 20. During operation of the X-ray tube 10, the anode 20 may be rotated at a high speed (e.g., 100 to 200 Hz) to spread the thermal energy resulting from the electron beam 32 striking the anode 20. Further, the space between the cathode assembly 14 and the anode 20 may be evacuated in order to minimize electron collisions with other atoms and to maximize an electric potential. In some X-ray tubes, voltages in excess of 20 kV are created between the cathode assembly 14 and the anode 20, causing electrons emitted by the cathode assembly 14 to become attracted to the anode 20.

The electron beam 32 is produced by the cathode assembly 14 and, more specifically, a cathode 34 that receives one or more electrical signals via a series of electrical leads 36. The electrical signals may be timing/control signals that cause the cathode 34 to emit the electron beam 32 at one or more energies and at one or more frequencies. The cathode 34 includes a central insulating shell 38 from which a mask 40 extends. The mask 40 encloses the leads 36, which extend to a cathode cup 42 mounted at the end of the mask 40. In some embodiments, the cathode cup 42 serves as an electrostatic lens that focuses electrons emitted from a thermionic filament within the cup 42 to form the electron beam 32.

As control signals are conveyed to cathode 34 via leads 36, the thermionic filament within cup 42 is heated and produces the electron beam 32. The beam 32 strikes the focal surface 30 of the anode 20 and generates X-ray radiation 46, which is diverted out of an X-ray aperture 48 of the X-ray tube 10. The direction and orientation of the X-ray radiation 46 may be controlled by a magnetic field produced outside of the X-ray tube 10 or by electrostatic means at the cathode 34. The field produced may generally shape the X-ray radiation 46 into a focused beam, such as a cone-shaped beam as illustrated. The X-ray radiation 46 exits the tube 10 and is generally directed towards a subject of interest during examination procedures.

As noted above, the X-ray tube 10 may be utilized in systems where the X-ray tube 10 is displaced relative to a patient, such as in CT imaging systems where the source of X-ray radiation rotates about a subject of interest on a gantry. Accordingly, it may be desirable that the X-ray tube 10 produce a suitable flux of X-rays so as to avoid noise generated from insufficient X-ray penetration while the X-ray tube 10 is in motion. To achieve such suitable X-ray flux, the X-ray tube 10 may generally include, as mentioned above, a number of features that are configured to allow the dispersion of thermal energy as the anode 20, which produces X-rays and thermal energy when bombarded with the electron beam 32, begins to heat during use. One such feature to control heat buildup in X-ray tubes is a rotating anode. Further, in accordance with the present approaches, one or more features may be placed proximate to the anode 20 to facilitate heat transfer from the anode 20 to other components of the X-ray tube 10.

FIG. 2 illustrates an embodiment of the anode assembly 12 wherein the anode 20 is supported in rotation by a spiral groove bearing (S GB) 60 that is lubricated by a liquid metal material. As noted above, however, the present approaches are also applicable to embodiments wherein the anode 20 is supported in rotation by other rotating features, such as a ball bearing, and the like. Embodiments of the SGB 60 may conform to those described in U.S. patent application Ser. No. 12/410,518 entitled “INTERFACE FOR LIQUID METAL BEARING AND METHOD OF MAKING SAME,” filed on Mar. 25, 2009, the full disclosure of which is incorporated by reference herein in its entirety. The SGB 60 is formed by the joining of a bearing sleeve 62 and a fixed shaft 64 around which the bearing sleeve 62 rotates during operation.

The anode 20, which generally has an annular shape with an annular opening proximate its center, is disposed about the bearing sleeve 62 in such a way so as to cause rotation of the anode 20 when the bearing sleeve 62 rotates. According to present embodiments, a metallurgical bonding layer 70 is disposed between the anode 20 and the bearing sleeve 62. The metallurgical bonding layer 70, in a general sense, is configured to facilitate the transfer of thermal energy from the anode 20 to the bearing sleeve 62 as the anode 20 heats as a result of electron bombardment. Further, the metallurgical bonding layer 70 may also transfer heat from the bearing sleeve 62 to the anode 20, such as in embodiments where rotation of the SGB 60 is utilized to generate thermal energy. To allow such heat transfer, the metallurgical bonding layer 70 is disposed between an axial face 72 of a shoulder 74 of the bearing sleeve 62. Such placement may be advantageous to allow heat to be removed from the bearing sleeve 62 by coolant that circulates within a coolant flow path 76 of the fixed shaft 64.

The metallurgical bonding layer 70 may be constructed from or include any number of materials capable of thermal energy transmission. In accordance with various embodiments of the present disclosure, the metallurgical bonding layer 70 may have a thermal conductivity of at least 100 Watts per Kelvin per meter (W·K⁻¹·m⁻¹). In some embodiments, the thermal conductivity may be between about 200 and 700 W·K⁻¹·m⁻¹. As an example, the metallurgical bonding layer 70 may include any or a combination of solder, alloys, or metals. Metals that may be utilized in accordance with present embodiments may include metals that are able to form alloys with the materials from which the anode 20 and bearing sleeve 62 are constructed, which may include steels, Kovar™ (iron-nickel-cobalt alloy), molybdenum (Mo), Mo alloy, tungsten (W), titanium (Ti), and/or zirconium (Zr). In one embodiment, the anode 20 may include TZM, a molybdenum-titanium-zirconium alloy, and the bearing sleeve 62 may include Mo alloy. Accordingly, the metallic bonding layer 70 may contain indium (In), tin (Sn), copper (Cu), nickel (Ni), gold (Au), silver (Ag), iron (Fe), aluminum (Al), and so on. In a general sense, the alloy material advantageously has low vapor pressure (e.g., <1×10⁻⁶ Torr) and remains solid at the operating temperature of the metallurgical bonding layer 70 so as to avoid X-ray tube instabilities. Further, the metallic bonding layer 70 may contain other elements which may be beneficial for heat conduction, thermal stability, and/or mechanical resilience, such as particulates of metals and/or various allotropes of carbon.

As noted above, the metallurgical bonding layer 70 is advantageously a rigid attachment between the anode 20 and the bearing sleeve 62. For example, the rigidity of the metallurgical bonding layer 70 helps to maintain the position of the anode 20 on the bearing sleeve 62 during rotation. Such positional maintenance may prevent imbalance within the X-ray tube 10 that can lead to tube unreliability and image noise, among others. The metallurgical bonding layer 70 may be sized based on the particular dimensions of the components of the X-ray tube 10 and other design considerations. To allow suitable thermal conduction, the thickness, in the longitudinal direction (i.e., the direction defined by the axis of SGB 60) of the metallurgical bonding layer 70 may be sized anywhere between approximately 1 micron (e.g., 1, 2, 3, 5, or 10 microns) and approximately 10 millimeters (mm) (e.g., 1, 2, 3, 5, or 10 mm) Further, the metallurgical bonding layer 70 may only partially extend up the axial face 72 of the bearing sleeve 62, may be substantially flush with the diametrical extent of the axial face 72, or may extend beyond the axial face 72.

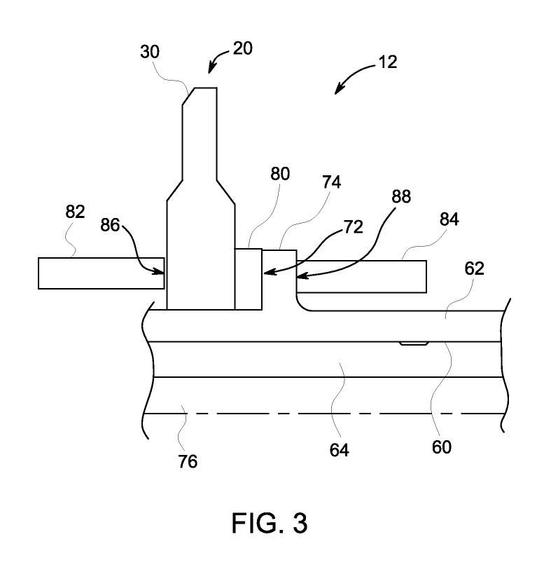

It should be noted that the operating temperatures of the X-ray tube 10 at the metallurgical bonding layer 70 may approach or exceed about 400° C. Accordingly, it may be desirable that the metallurgical bonding layer 70 have a melting point of at least 400° C., such as 420, 450, 500, 550, 600° C. or more. The combination of high thermal stability and rigidity during use of the metallurgical bonding layer 70 may avoid the production of small particulates that may be produced, for example, as a result of shear forces between the anode 20 and the bearing sleeve 62. Such particulates may, in certain situations, be detrimental to the operation of the X-ray tube 10. For example arcing caused by the particulates (e.g., when the particulates are struck by the electron beam 32) may occur, and/or the vacuum within the tube 12 may be decreased due to the increased presence of particulates. Accordingly, the rigid metallurgical bonding layer 70 advantageously prevents undesirable arcing and loss of vacuum, prolonging the life of the X-ray tube 10. As noted above, FIGS. 3-5 illustrate embodiments of configurations to dispose the metallurgical bonding layer 70 between the anode 20 and the bearing sleeve 62.

Specifically, FIG. 3 illustrates an embodiment wherein a metallic braze 80 is disposed between the axial face 72 of the shoulder 74 of the bearing sleeve 62 and the anode 20. In accordance with the illustrated embodiment, the metallic braze 80 may be melted via the application of localized heat. Such localized heating is accomplished by the conduction of a current through the anode 20, the metallic braze 80, and the bearing sleeve 62. The current may be applied via a first electrode 82 and a second electrode 84. The first electrode 82 may be disposed on an axial face 86 of the anode 20 opposite the side of the metallic braze 80, while the second electrode 84 is disposed on a second axial face 88 of the shoulder 74 of the bearing sleeve 62, also opposite the side of the metallic braze 80. In this way, the electrodes 82, 84, the anode 20, the metallic braze 80, and the bearing sleeve 62 form a circuit.

By passing a current through the formed circuit, the areas proximate the electrodes 82, 84 may experience localized heating, the extent of which may depend on the applied electrical potential as well as the materials from which the anode 20, the metallic braze 80, and the bearing sleeve 62 are formed or include. The application of such localized heat may heat the metallic braze 80 above its melting point, which allows it to form a metallurgical bond with the surfaces to which it is in contact, namely the axial faces of the anode 20 and the bearing sleeve shoulder 74. It should be noted that while the localized temperature may exceed the normal operating temperatures of the X-ray tube 10, the localized heat substantially remains in the area proximate the electrodes 82, 84, which prevents the bearing 60 from experiencing temperatures which may damage components and/or prevent suitable operation.

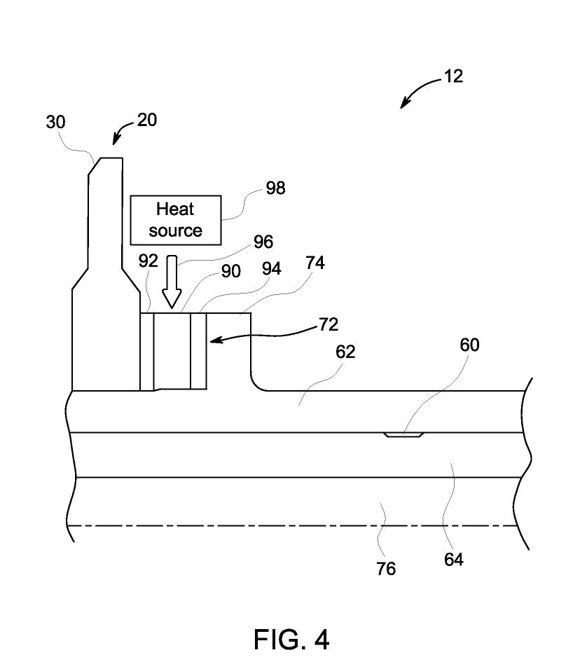

The approach to forming a metallurgical bonding layer described above with respect to FIG. 3 may generally be applicable to most X-ray tubes. However, in other embodiments, it may be desirable to utilize an approach wherein more than one metal is used to form an alloy having a higher melting temperature than the pure metals from which it is formed. FIG. 4 illustrates one such embodiment provided in the context of the anode assembly 12, wherein the metallurgical bonding layer 70 is a Cu—In—Sn or similar alloy.

Specifically, in the illustrated embodiment, the metallurgical bonding layer 70 is formed via a transient liquid phase bond. Between the anode 20 and the axial face 72 of the bearing sleeve shoulder 74, a metallic gasket 90, such as a Cu gasket, is disposed between a pair of solder layers 92, 94. The solder layers 92, 94 are disposed against the surface of the anode 20 and the axial face 72, respectively, and may contain metals such as Cu, Ag, Sn, In, bismuth (Bi), silicon (Si), and similar solder materials. According to present embodiments, the solder layers 92, 94 have a melting temperature that is lower than the highest operational temperature of the X-ray tube (e.g., between approximately 125 and 400° C.). The entire anode assembly 12, and, in some embodiments, the entire X-ray tube 10, is then heated, depicted generally by an arrow 96, by a heat source 98 to a temperature at which the solder (e.g., an In—Sn solder) melts. The heat source 98 may be any source capable of transmitting thermal energy to the X-ray tube 10, X-ray tube 10, and/or the anode assembly 12.

Upon transmittal of a suitable amount of heat 96, the melted solder then undergoes a metallurgical reaction with the metallic gasket 90. The resulting metallurgical bond may be a permanent bond, and may include an alloy, for example a Cu—In—Sn alloy. Indeed, because the solder is melted while in direct contact with the surfaces of the anode 20 and the axial face 72, a permanent bond is formed between the Cu—In—Sn or similar alloy, the anode 20, and the bearing sleeve 62. Therefore, as noted above, heat generated from the bombardment of the anode 20 with the electron beam 32 may be at least partially transferred from the anode 20, thorough the metallurgical bonding layer 70 (e.g., the Cu—In—Sn or similar alloy), through the bearing sleeve 62, and to the fixed shaft 64 where the thermal energy may be removed by coolant (e.g., oil) circulating through the coolant flow path 76 disposed in the center thereof.

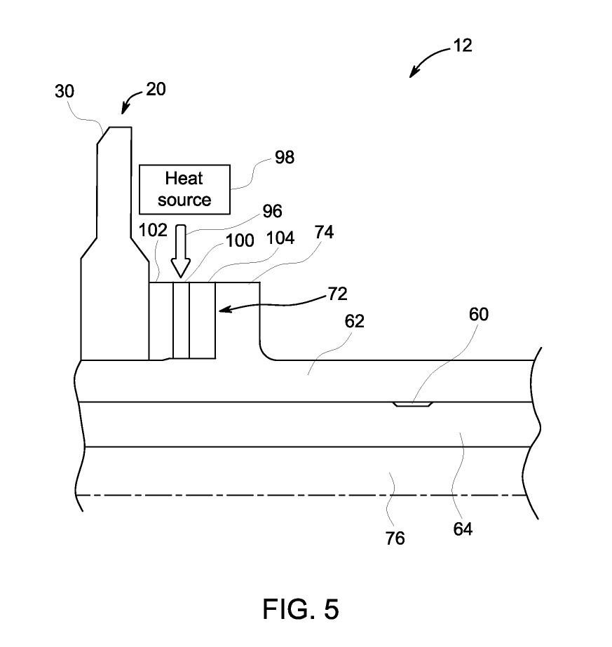

FIG. 5 illustrates a similar approach to that illustrated with respect to FIG. 4, wherein the metallurgical bonding layer 70 is formed from a mixture of metals. However, rather than having a metallic gasket disposed between two solder layers, the embodiment of FIG. 5 forms the metallurgical bonding layer 70 via a transient liquid phase bond using a solder layer 100 disposed between two brazed metallic layers 102, 104. For example, the metallic layers 102, 104 may be bonded to the anode 20 and the shoulder 74 prior to introduction of the solder layer 100 (e.g., prior to assembly of the anode assembly 12). The brazed metallic layers may include Cu and alloys thereof, Ag, Au, Ni, Al, Fe, Si, boron (B), phosphorous (P), and the like.

The solder layer 100 may generally include Cu, Ag, Sn, In, Bi, Si, and similar solder materials, as noted above with respect to FIG. 4. According to present embodiments, the solder layer 100 may have a melting temperature that is below the temperature at which the X-ray tube 10 experiences maximum operational temperatures. As an example, the solder layer 100 may have a melting temperature between about 125 and 400° C. In one embodiment, the solder layer is an In—Sn solder and the metallic layers 102, 104 are brazed Cu.

To form the metallurgical boding layer 70, when the solder layer 100 is in place (e.g., between the brazed metallic layers 102, 104), the heat source 98 provides heat 96 to the entire anode assembly 12 (e.g., to the X-ray tube 10). The anode assembly 12 may be heated above the melting temperature of the solder layer 100 (e.g., to between about 125 and 400° C.). The liquefied solder then undergoes a metallurgical reaction to form an alloy of the solder materials and the braze materials. The resulting alloy advantageously has a melting temperature above the maximum operating temperature of the X-ray tube (e.g., above 400° C.), such that the anode 20 and the sleeve 26 remain bonded by a solid bonding layer throughout operation. Such a permanent bonding layer allows substantially constant thermal conduction between at least the anode 20 and the bearing sleeve 62.

In accordance with another aspect of the present disclosure, FIG. 6 illustrates, by way of a process flow diagram, a method 110 of making and using an X-ray tube having a thermally conductive metallurgical bonding layer. The method 110 generally begins by disposing a bearing sleeve about a fixed shaft (block 112). The joining between the bearing sleeve and the fixed shaft may generally be considered a bearing. As noted in the above embodiments, the bearing may be a spiral groove bearing.

After performing the acts represented by block 112, an electron beam target (i.e., an anode) is then disposed about the bearing sleeve (block 114). Once the electron beam target is in a desirable place, the electron beam target is bonded to the bearing sleeve using a metallurgical bonding layer (block 116). As an example, one or more metallic gaskets may be disposed between an axial face of a shoulder of the bearing sleeve and the electron beam target, followed by melting the one or more metallic gaskets to form an alloy that fixedly attaches (e.g., permanently attaches) the electron beam target to the bearing sleeve. In some embodiments, the electron beam target and the bearing sleeve may be pre-treated such that a metallic braze is appended to each. The metallic braze may serve as a reactant metal in a metallurgical reaction that allows an alloy to be formed that bonds the electron beam target to the bearing sleeve. In such an embodiment, the one or more metallic gaskets may include a solder layer that melts at a low temperature (e.g., between about 125 and 400° C.) to start the metallurgical reaction.

Accordingly, it should be noted that the metallic gaskets that form the metallurgical bonding layer may be disposed on the bearing sleeve prior to disposing the target thereon. However, in other embodiments, the metallic gaskets that form the metallurgical bonding layer may be semi-circular or have a slit that allow them to be pulled over the bearing sleeve. In such a configuration, once the metallic gaskets have been melted, they may fill any voids between the electron beam target and the bearing sleeve through capillary action.

After performing the acts represented by blocks 112-116 as well as any other X-ray tube manufacturing processes, the X-ray tube may be utilized. In use, the bearing (e.g., the SGB) is rotated (block 118), followed by bombardment of the electron beam target with an electron beam (block 120). As noted above with respect to FIG. 1, the electron beam is generated by a cathode assembly having a thermionic emitter. The electron beam strikes the electron beam target, which produces at least X-rays and thermal energy. At least a portion of the thermal energy is then transferred from the electron beam target to the bearing sleeve through the thermally conductive metallurgical bonding layer (block 122). As previously discussed, the metallurgical bonding layer may be an alloy or similar material that prevents non-rotational motion of the electron beam target while maintaining thermal conduction throughout examination, warmup, and/or cooldown sequences.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An X-ray tube comprising:
a fixed shaft;
a rotating bearing sleeve disposed about the fixed shaft and configured to rotate with respect to the fixed shaft via a rotary bearing; and
an electron beam target disposed about the bearing sleeve and configured to rotate with the bearing sleeve, the electron beam target being permanently bonded to the bearing sleeve.

2. The X-ray tube of claim 1, wherein the bearing sleeve comprises a shoulder having an axial face, and wherein the target is bonded to the axial face of the shoulder.

3. The X-ray tube of claim 2, wherein the target is bonded to the axial face of the shoulder via a metallic bonding layer disposed between the target and the axial face of the shoulder.

4. The X-ray tube of claim 3, wherein the bonding layer comprises a brazing material.

5. The X-ray tube of claim 3, wherein the bonding layer comprises a transient liquid phase bond.

6. The X-ray tube of claim 5, wherein the transient liquid phase bond comprises layers of solder and gasket material that form an alloy when the target is bonded to the bearing sleeve.

7. The X-ray tube of claim 6, wherein the transient liquid phase bond comprises a copper layer and an indium-tin solder.

8. The X-ray tube of claim 7, wherein the transient liquid phase bond comprises, prior to bonding, a copper layer between two indium-tin solder layers.

9. The X-ray tube of claim 7, wherein the transient liquid phase bond comprises, prior to bonding, an indium-tin solder between two copper layers.

10. An X-ray tube comprising:
a fixed shaft;
a rotating bearing sleeve disposed about the fixed shaft and configured to rotate with respect to the fixed shaft via a rotary bearing, the bearing sleeve comprises a shoulder having an axial face;
an electron beam target disposed about the bearing sleeve and configured to rotate with the bearing sleeve; and
a bonding layer disposed between the axial face of the shoulder and the electron beam target for securing the target to the bearing sleeve.

11. The X-ray tube of claim 10, wherein the bonding layer comprises a brazing material.

12. The X-ray tube of claim 10, wherein the bonding layer comprises a transient liquid phase bond.

13. The X-ray tube of claim 12, wherein the transient liquid phase bond comprises layers of solder and gasket material that form an alloy when the target is bonded to the bearing sleeve.

14. The X-ray tube of claim 13, wherein the transient liquid phase bond comprises a copper layer and an indium-tin solder.

15. The X-ray tube of claim 13, wherein the transient liquid phase bond comprises, prior to bonding, a copper layer between two indium-tin solder layers.

16. The X-ray tube of claim 13, wherein the transient liquid phase bond comprises, prior to bonding, an indium-tin solder between two copper layers.

17. A method for making an X-ray tube, comprising:
disposing a rotating bearing sleeve about a fixed shaft, the bearing sleeve comprising a shoulder having an axial face;
disposing an electron beam target about the bearing sleeve, the electron beam target being rotatable with the bearing sleeve during operation; and
bonding the target and the axial face of the bearing sleeve shoulder.

18. The method of claim 17, wherein the target is bonded to the axial face of the shoulder via a metallic bonding layer disposed between the target and the axial face of the shoulder.

19. The method of claim 18, wherein the bonding layer comprises a brazing material.

20. The method of claim 18, wherein the bonding layer comprises a transient liquid phase bond.
